(19) United States
(12) Patent Application Publication
(10) Pub. No.: US 2007/0161529 A1
(43) Pub. Date: Jul. 12, 2007

(54) CLEANING COMPOSITION FOR SEMICONDUCTOR DEVICE-MANUFACTURING APPARATUS AND CLEANING METHOD

(75) Inventors: Fumiharu Takahashi, Syunan-shi (JP); Yasushi Hara, Syunan-shi (JP); Hiroaki Hayashi, Hikari-shi (JP); Akinori Shimono, Syunan-shi (JP)

Correspondence Address: SUGHRUE MION, PLLC, 2100 PENNSYLVANIA AVENUE, N.W., SUITE 800, WASHINGTON, DC, 20037, US

(73) Assignee: TOSOH CORPORATION, Shunan-shi (JP)

(21) Appl. No.: 11/614,760

(22) Filed: Dec. 21, 2006

(30) Foreign Application Priority Data
Dec. 22, 2005 (JP) 2005-369076
Dec. 22, 2005 (JP) 2005-369075

(51) Int. Cl. C23G 1/00; C23G 1/02; B08B 9/00; C11D 7/32

(52) U.S. Cl. 510/175; 134/22.1; 134/2; 134/3

(57) ABSTRACT

A cleaning composition for a semiconductor device-manufacturing apparatus comprising, based on the weight of the composition, 0.1-10% by weight of at least one fluorine compound selected from sodium fluoride, potassium fluoride, lithium fluoride and ammonium fluoride; 1-50% by weight of at least one phosphoric ingredient selected from phosphoric acid and a phosphoric acid salt; 0.5-35% by weight of hydrogen peroxide; 0-5% by weight of hydrofluoric acid, and the remainder of water, wherein the ratio (H₂O₂/F) by weight of hydrogen peroxide to fluorine in the total of the fluorine compound and the hydrofluoric acid is at least 4. The cleaning composition is used for cleaning semiconductor device-manufacturing apparatus having deposited thereon at least one deposited metal ingredient selected from metallic titanium, titanium oxide, titanium nitride, metallic copper, copper oxide, metallic tantalum, tantalum oxide and tantalum nitride to remove these deposited metal ingredients.

### BACKGROUND OF THE INVENTION

(1) Field of the Invention

This invention relates to a cleaning composition for a semiconductor device-manufacturing apparatus. Further, it relates to a method of cleaning a semiconductor device-manufacturing apparatus using the cleaning composition. More specifically, it relates to a method of cleaning a shield provided in a CVD or sputtering apparatus, on which a metal ingredient such as metallic titanium, titanium oxide, titanium nitride, metallic copper, copper oxide, metallic tantalum, tantalum oxide or tantalum nitride has been deposited, to remove the deposited metal ingredient.

(2) Description of the Related Art

In the process of manufacturing a semiconductor device, a metal such as titanium, copper or tantalum is sputtered to be deposited on a wafer. When the metal is sputtered, it is deposited not only on a wafer but also on the semiconductor device-manufacturing apparatus.

A CVD apparatus and a sputtering apparatus are usually provided with a shield for preventing undesirable deposition of sputtered metal, which shield is made of, for example, aluminum or stainless steel. When a metal is sputtered to be deposited on a wafer, the metal is also deposited on the shield. When a multiplicity of wafers are treated, the thickness of metal deposited on the shield increases and occasionally reaches an unacceptable level for the safe operation of apparatus. Therefore the metal deposited on the shield must be removed at a predetermined interval.

A method of removing a metal such as titanium or copper is well known. For example, U.S. Pat. No. 4,925,813 discloses a method of removing titanium oxide deposited on a wafer with hydrofluoric acid in the process of the manufacturing a semiconductor device. Hydrofluoric acid has enhanced function of dissolving titanium for its removal, but, gives damage to aluminum or stainless steel. Therefore this method cannot be adopted in the case when a shield made of aluminum or stainless steel is provided in the semiconductor device-manufacturing apparatus.

As a cleaning composition for removing metallic titanium, an etching solution containing hydrofluoric acid or nitric acid is also well known (see, for example, European Patent 0 634 498 A1 ). The etching solution containing hydrofluoric acid or nitric acid also gives damage to aluminum or stainless steel, and therefore, metallic titanium cannot be removed with a high selectivity.

It has been proposed in U.S. Pat. No. 4,353,779 to etch a III/V group semiconductor material such as GaP, AlAs and GaAs with an etching solution consisting essentially of fluorine ion, phosphoric acid and hydrogen peroxide, in the process for manufacturing a semiconductor device. It has also been proposed in Japanese Unexamined Patent Publication H9-31669 to etch a reed frame with an etching solution containing sulfuric acid, hydrochloric acid, and nitric acid, phosphoric acid or an organic acid, simultaneously with removal of burrs, as a pre-treatment for plating the read frame with a solder. However, these proposals are concerned with an etching technique in the process of manufacturing a semiconductor device, and the above-cited patents are silent on cleaning of the semiconductor device-manufacturing apparatus. Further, these patents teach nothing about the prevention or minimization of damage given to a specific metal such as aluminum or stainless steel.

It has been proposed in Japanese Unexamined Patent Publication 2004-43850 to etch metallic titanium or a titanium alloy with an aqueous etching solution containing hydrogen peroxide, a fluoride, phosphoric acid and a fluorine-containing surface active agent, simultaneously with removal of surface scales and smoothing of the titanium surface. This etching solution has good capability of dissolving titanium in the case when the ratio (H₂O₂/F) by weight of hydrogen peroxide to fluorine in the fluoride is not larger than 3. However, the etching solution gives damage to aluminum and stainless steel, and therefore, this solution cannot be adopted in a semiconductor device-manufacturing apparatus provided with a shield made of aluminum or stainless steel.

Thus, the conventional etching solution for a semiconductor device-manufacturing apparatus was different or impossible to adopt as a cleaning liquid for selectively removing titanium, copper, tantalum or other metals, deposited on a shield made of aluminum or stainless steel, without damage of the shield at the step of cleaning the apparatus.

### SUMMARY OF THE INVENTION

A primary object of the present invention is to provide a cleaning composition for a semiconductor device-manufacturing apparatus, which is capable of removing metal ingredients, deposited on a shield, such as metallic titanium, titanium oxide, titanium nitride, metallic copper, copper oxide, metallic tantalum, tantalum oxide and tantalum nitride with an enhanced selectivity, without giving damage to shield materials such as aluminum, aluminum alloy and stainless steel.

Another object is to provide a method of cleaning a semiconductor device-manufacturing apparatus provided with a shield made of the above-mentioned shield material, by using the above-mentioned cleaning composition, for removing the metal ingredients deposited on the shield.

In one aspect of the present invention, there is provided a cleaning composition for a semiconductor device-manufacturing apparatus comprising, based on the weight of the composition:
0.1 to 10% by weight of at least one fluorine compound selected from the group consisting of sodium fluoride, potassium fluoride, lithium fluoride and ammonium fluoride,
1 to 50% by weight of at least one phosphoric ingredient selected from the group consisting of phosphoric acid and a phosphoric acid salt,
0.5 to 35% by weight of hydrogen peroxide,
0 to 5% by weight of hydrofluoric acid, and
the remainder of water;
   wherein the ratio (H₂O₂/F) by weight of the amount of hydrogen peroxide to the amount of fluorine in the total of the fluorine compound and the hydrofluoric acid is at least 4.

In another aspect of the present invention, there is provided a method of cleaning a semiconductor device-manufacturing apparatus, which comprises cleaning a semiconductor device-manufacturing apparatus having deposited thereon at least one deposited metal ingredient selected from metallic titanium, titanium oxide, titanium nitride, metallic copper, copper oxide, metallic tantalum, tantalum oxide and tantalum nitride with the above-mentioned cleaning composition to remove the deposited metal ingredient.

### DETAILED DESCRIPTION OF THE INVENTION

The cleaning composition according to the present invention comprises a specific fluorine compound, phosphoric acid and/or its salt, hydrogen peroxide and optional hydrofluoric acid.

The specific fluorine compound contained in the cleaning composition refers to sodium fluoride, potassium fluoride, lithium fluoride and ammonium fluoride. These fluorine compounds may be used either alone or as a combination of at least two thereof. Of these fluorine compounds, sodium fluoride is preferable because it gives damage to a shield material such as aluminum only to an minimized extent, and it is inexpensive and readily available. Fluorides other than the above-recited fluorides are not advantageous in view of poor solubility in water or expensiveness.

The amount of the specific fluorine compound is 0.1 to 10% by weight, preferably 0.1 to 5% by weight, based on the weight of the cleaning composition. If the amount of the specific fluorine compound is too small, the rate of removal of metal ingredients deposited on the shield is low to an industrially unacceptable extent. In contrast, if the amount of the specific fluorine compound is too large, the damage to the shield material such as aluminum becomes large to an undue extent.

The phosphoric acid contained in the cleaning composition of the present invention includes orthophosphoric acid, metaphosphoric acid and polyphosphoric acid. These phosphoric acids may be used either alone or in combination.

The salt of phosphoric acid as used in the present invention refers to salts of the above-recited phosphoric acids, and includes normal salts, i.e., tertiary phosphates; primary salts, i.e., dihydrogen salts; and secondary phosphates, i.e., monohydrogen phosphates. These phosphoric acids can be used without any limitation provided that they are soluble in water.

The amount of phosphoric ingredient, i.e., phosphoric acid and/or phosphoric acid salt is 1 to 50% by weight, preferably 20 to 40% by weight, based on the weight of the cleaning composition. If the amount of phosphoric acid and/or phosphoric acid salt is too small, the rate of removal of metal ingredients deposited on the shield is low to an industrially unacceptable extent. In contrast, if the amount of phosphoric acid and/or phosphoric acid salt is too large, the damage to the shield material such as aluminum becomes large to an undue extent.

Hydrogen peroxide as used in the present invention is not particularly limited, and commercially available hydrogen peroxide can be used. The amount of hydrogen peroxide is 0.5 to 35% by weight, preferably 2 to 20% by weight, based on the weight of the cleaning composition. If the amount of hydrogen peroxide is too small, the damage to the aluminum shield material is large. In contrast, if the amount of hydrogen peroxide is too large, there is a danger of explosion and the cleaning composition is difficult to handle with safety.

The cleaning composition of the present invention may contain hydrofluoric acid. By the incorporation of hydrofluoric acid, the amount of the fluorine compound such as sodium fluoride can be reduced, and the reduction of removal rate can be avoided. Further, damage to the shield material such as aluminum can be further minimized. That is, when hydrofluoric acid is not incorporated in combination with the above-mentioned fluorine compound, the damage to the shield material is large as compared with the case when hydrofluoric acid is used. As the hydrofluoric acid, those which have a high purity and are used in electronic industry are preferable.

The amount of hydrofluoric acid varies depending upon the concentration of the above-mentioned specific fluorine compound, and is chosen in the range of 0 to 5% by weight, preferably 0.1 to 3% by weight.

In the cleaning composition of the present invention, the ratio (H₂O₂/F) by weight of the amount of hydrogen peroxide to the amount of fluorine in the total of the fluorine compound and the optional hydrofluoric acid must be at least 4. If this ratio is smaller than 4, damage to the shield material is undesirably large.

The remainder other than the above-mentioned fluorine compound, phosphoric acid and/or phosphoric acid salt, hydrogen peroxide and optional hydrofluoric acid in the cleaning composition is water.

The cleaning composition of the present invention may comprise a corrosion inhibitor for the shield material such as aluminum.

The cleaning of a semiconductor device-manufacturing apparatus for the removal of metal ingredients deposited on a shield or other member is preferably carried out at a temperature in the range of 0 to 100° C. At a temperature lower than 0° C., the rate of removal of deposited metal ingredients is low to an industrially unacceptable extent. In contrast, at a temperature higher than 100° C., the concentration and uniformity of the cleaning composition easily vary, and thus such a high temperature is not advantageous from an industrial viewpoint.

The cleaning composition of the present invention is suitable for the removal of deposited metal ingredients such as metallic titanium, titanium oxide, titanium nitride, metallic copper, copper oxide, metallic tantalum, tantalum oxide and tantalum nitride. These metal ingredients can be conducted without difficulty. Thus, the cleaning of the semiconductor device-manufacturing apparatus can be conducted without substantial damage to the shield material such as aluminum, aluminum alloy or stainless steel.

The present invention will now be specifically described by the following examples and comparative examples, that by no means limit the scope of the invention.

In the examples and comparative examples, the following abbreviations are used.

NaF: sodium fluoride

HF: hydrofluoric acid

PA: phosphoric acid

SHP: sodium dihydrogenphosphate

HPO: hydrogen peroxide

### Examples 1-4, Comparative Examples 1-6

Titanium or copper was sputtered to be deposited into a film with a thickness of 0.1 mm on an aluminum or stainless steel (SUS 316L) substrate. The aluminum or stainless steel substrate having titanium or copper deposited thereon was immersed in a bath of each cleaning liquid composition shown in Table 1 at a predetermined temperature.

The rate of removal of the deposited titanium or copper was evaluated by measuring the time required for the complete removal of titanium or copper. The rate of removal of titanium or copper was expressed by the following two ratings.

A: titanium or copper was completely removed within 6 hours

B: more than 6 hours were required for the complete removal of titanium or copper

The damage to the aluminum or stainless steel substrate was evaluated by measuring the thickness of the corroded portion of substrate, and expressed by the following two ratings.

A: damage to the substrate was 0.01 mm or smaller

B: damage to the substrate was larger than 0.01 mm.

The results are shown in Table 1.

### Examples 5-7, Comparative Examples 7-9

Tantalum was sputtered to be deposited into a film with a thickness of 0.1 mm on an aluminum or stainless steel (SUS 316L) substrate. The aluminum or stainless steel substrate having tantalum deposited thereon was immersed in a bath of each cleaning liquid composition shown in Table 2 at a predetermined temperature.

The number of days required for the complete removal of the deposited tantalum was measured. The damage to the aluminum or stainless steel substrate was evaluated by the same method and expressed by the same two ratings, as described above in Examples 1-4 and Comparative Examples 1-6. The results are shown in Table 2.

TABLE 1

| | Formulation of Cleaning Liquid Composition | | | | | | | Rate of | | | |
|---|---|---|---|---|---|---|---|---|---|---|---|
| | (% by weight; the balance: water) | | | | | | Temp. | Removal | | Damage | |
| | NaF | HF | PA | SHP | HPO | HPO/F | (° C.) | Ti | Cu | Al | SUS316L |
| Example 1 | 3 | | 30 | | 20 | 14.7 | 40 | A | A | A | A |
| Example 2 | 2 | | 30 | | 20 | 22.2 | 25 | A | A | A | A |
| Example 3 | 1 | 1 | 20 | | 24 | 17.1 | 40 | A | A | A | A |
| Example 4 | 2 | | | 15 | 27 | 30.0 | 50 | A | A | A | A |
| Comp. Ex. 1 | 3 | | | | 20 | 14.7 | 40 | B | B | A | A |
| Comp. Ex. 2 | 2 | | 30 | | 3 | 3.3 | 25 | A | A | B | B |
| Comp. Ex. 3 | 1 | 1 | 20 | | 4 | 2.9 | 40 | A | A | B | B |
| Comp. Ex. 4 | | | 30 | | | | 40 | B | B | A | A |
| Comp. Ex. 5 | | 1 | | | | | 40 | A | A | B | B |
| Comp. Ex. 6 | | 1 | 20 | | 24 | 25.3 | 40 | A | A | B | B |

TABLE 2

| | Formulation of Cleaning Liquid Composition | | | | | | | | | |
|---|---|---|---|---|---|---|---|---|---|---|
| | (% by weight; the balance: water) | | | | | | Temp. | Days | Damage | |
| | NaF | HF | PA | SHP | HPO | HPO/F | (° C.) | Ta | Al | SUS316L |
| Example 5 | 3 | | 10 | | 25 | 18.4 | 30 | 2 | A | A |
| Example 6 | 2 | | 30 | | 20 | 22.2 | 40 | 1 | A | A |
| Example 7 | 1 | 1 | | 15 | 25 | 17.9 | 50 | 1 | A | A |
| Comp. Ex. 7 | 3 | | | | 25 | 18.4 | 40 | >7 | A | A |
| Comp. Ex. 8 | | | 30 | | 20 | — | 40 | >7 | A | A |
| Comp. Ex. 9 | 1 | 1 | | 15 | | — | 40 | 2 | B | B |

1. A cleaning composition for a semiconductor device-manufacturing apparatus comprising, based on the weight of the composition:
0.1 to 10% by weight of at least one fluorine compound selected from the group consisting of sodium fluoride, potassium fluoride, lithium fluoride and ammonium fluoride,
1 to 50% by weight of at least one phosphoric ingredient selected from the group consisting of phosphoric acid and a phosphoric acid salt,
0.5 to 35% by weight of hydrogen peroxide,
0 to 5% by weight of hydrofluoric acid, and
the remainder of water;
wherein the ratio (H₂O₂/F) by weight of the amount of hydrogen peroxide to the amount of fluorine in the total of the fluorine compound and the hydrofluoric acid is at least 4.

2. The cleaning composition for a semiconductor device-manufacturing apparatus according to claim 1, wherein the amount of the fluorine compound is in the range of 0.1 to 5% by weight.

3. The cleaning composition for a semiconductor device-manufacturing apparatus according to claim 1, wherein the phosphoric acid is at least one phosphoric acid selected from the group consisting of orthopedic acid, metaphosphoric acid and polyphosphoric acid.

4. The cleaning composition for a semiconductor device-manufacturing apparatus according to claim 1, wherein the amount of the phosphoric ingredient is in the range of 20 to 40% by weight.

5. The cleaning composition for a semiconductor device-manufacturing apparatus according to claim 1, wherein the amount of hydrogen peroxide is in the range of 2 to 20% by weight.

6. The cleaning composition for a semiconductor device-manufacturing apparatus according to claim 1, wherein the amount of hydrofluoric acid is in the range of 0.1 to 3% by weight.

7. A method of cleaning a semiconductor device-manufacturing apparatus which comprises cleaning a semiconductor device-manufacturing apparatus having deposited thereon at least one deposited metal ingredient selected from metallic titanium, titanium oxide, titanium nitride, metallic copper, copper oxide, metallic tantalum, tantalum oxide and tantalum nitride with a cleaning composition to remove the deposited metal ingredient, wherein said cleaning composition comprises, based on the weight of the composition:
0.1 to 10% by weight of at least one fluorine compound selected from the group consisting of sodium fluoride, potassium fluoride, lithium fluoride and ammonium fluoride,
1 to 50% by weight at least one phosphoric ingredient selected from the group consisting of phosphoric acid and a phosphoric acid salt,
0.5 to 35% by weight of hydrogen peroxide,
0 to 5% by weight of hydrofluoric acid, and
the remainder of water;
wherein the ratio (H₂O₂/F) by weight of the amount of hydrogen peroxide to the amount of fluorine in the total of the fluorine compound and the hydrofluoric acid is at least 4.

8. The method of cleaning a semiconductor device-manufacturing apparatus according to claim 7, wherein the semiconductor device-manufacturing apparatus provided with a shield made of aluminum, an aluminum alloy or stainless steel is cleaned with the cleaning composition to remove said at least one deposited metal ingredient which is deposited on the shield.

9. The method of cleaning a semiconductor device-manufacturing apparatus according to claim 7, wherein the amount of the fluorine compound in the cleaning composition is in the range of 0.1 to 5% by weight.

10. The method of cleaning a semiconductor device-manufacturing apparatus according to claim 7, wherein the phosphoric acid is at least one phosphoric acid selected from the group consisting of orthophosphoric acid, metaphosphoric acid and polyphosphoric acid.

11. The method of cleaning a semiconductor device-manufacturing apparatus according to claim 7, wherein the amount of the phosphoric ingredient in the cleaning composition is in the range of 20 to 40% by weight.

12. The method of cleaning a semiconductor device-manufacturing apparatus according to claim 7, wherein the amount of hydrogen peroxide in the cleaning composition is in the range of 2 to 20% by weight.

13. The method of cleaning a semiconductor device-manufacturing apparatus according to claim 7, wherein the amount of hydrofluoric acid in the cleaning composition is in the range of 0.1 to 3% by weight.
